(19) United States
(12) Patent Application Publication
(10) Pub. No.: US 2008/0212950 A1
(43) Pub. Date: Sep. 4, 2008

(54) Title Substitution on Dvd+Rw Video Format Discs

(75) Inventor: Ronald Johannes Cornelis Geerlings, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/997,669

(22) PCT Filed: Aug. 2, 2006
(86) PCT No.: PCT/IB2006/052654

§ 371 Date: Feb. 1, 2008

Related U.S. Application Data
(60) Provisional application No. 60/705,615, filed on Aug. 4, 2005.

(51) Int. Cl. H04N 7/173

(52) U.S. Cl. 386/125

(57) ABSTRACT

A navigation structure and method is provided to provide a user with additional information for better user-interaction and understanding of a DVD+RW (DVD-Rewritable) optical disc. More particularly, a user interacting with a menu system of a DVD+RW disc is provided with a visual and/or audible instruction or warning, in response to the user selecting a non-playable title (14) from the menu system. The instruction or warning explains to the user why the selected title (14) cannot be played back and that a next title (16) will be presented in a certain period of time or after a user interaction.

The present invention relates to an optical disc recording apparatus and method thereof for providing a user with additional information for better user-interaction and understanding of a DVD-RW (DVD-Rewritable) optical disc.

In recent years, systems for playing back the contents of optical discs such as video CDs that record video data, audio data, and the like have been developed, and have prevailed for the purpose of playing back movie software titles, karaoke data, and the like.

Among such systems, the DVD (Digital Versatile Disk) standard employing the internationally standardized MPEG-2 scheme and the AC (Audio Compression)-3 or other audio compression schemes has been proposed. The DVD standard covers playback-only DVD video (or DVD-ROM (Read-Only Memory)), write-once DVD-R (Recordable), rewritable DVD-RAM (Random Access Memory) (or DVD-RW, DVD+RW (Rewritable)).

The DVD+RW (Rewritable) format allows ‘titles’ to be recorded, edited and deleted. A ‘title’ refers to a user playable program, for example a movie, constituted by a sequence of cells where a cell comprises a sequence of units and corresponding control information. In addition, a video content protection system allows a ‘title’ to be encrypted. DVD-Video typically uses a content protection scheme known as the content-scrambling system (CSS). CSS and other content protection schemes make use of encryption and cryptographic key exchange between encrypted DVD disc sectors and decrypting components. A more recent encryption method for DVD+RW encryption, Video Content Protection Method (VCPS), allows recorded titles to be encrypted.

A drawback of encrypting titles in the DVD+RW format is that when a user selects an encrypted ‘title’, the ‘title’ is not playable and the player skips to the next title on the disc. This also occurs when the user selects an empty ‘title’. This is confusing to the user in that a different ‘title’ is being played than the one selected.

It would therefore be desirable to provide a user with a visual and/or audible instruction or warning explaining why a title selected on a DVD+RW formatted disc cannot be played back and that a next title will be presented in a certain period of time or after a user interaction.

The present invention is directed to a method and navigation structure for providing a user with additional information for better user-interaction and understanding of a DVD+RW (DVD-Rewritable) optical disc. More particularly, a method, according to the invention, provides a user, interacting with a menu system of a DVD+RW disc, with a visual and/or audible instruction or warning, in response to the user selecting an empty or encrypted title from the menu system. The instruction or warning explains to the user why the selected title cannot be played back and that a next title will be presented in a certain period of time or after a user interaction.

The invention overcomes certain limitations of the DVD+RW format including: (1) precluding the addition of information titles and warnings to the Video Title Set Menu (VTSM) of a disc to explain to the user why a selected title cannot be played back and (2) restricting direct jumps from the VTS domain to a title in the VMG domain. It is noted that, unlike the DVD+RW format, the addition of information titles and warnings to the Video Title Set, menu's are allowed in the DVD format.

The inventor has recognized that it is possible to add information titles and warnings to a DVD+RW disc to inform a user why a title cannot be played, without violating the aforementioned limitations of the DVD-Video and DVD+RW video specifications. The DVD-Video and DVD+RW video specifications are incorporated by reference herein in their entirety.

In accordance with one aspect, an optical disc including a navigation structure is provided for redirecting a title from the VTS domain to an information screen in the VMG domain, without disrupting the DVD+RW video structures. In particular, two pre-commands are added to a VTS PGC (title) Command Table, three PGC pre-commands are added to the VMGM entry PGC Command Table and an information page is added to the VMGM VOBS.

According to a preferred embodiment, when a user selects an empty or encrypted title from the disc menu of a DVD+RW formatted disc, the corresponding program chain (PGC) in the video title set (VTS) on the disc is executed. Before the playback of the encrypted (or empty) title is initiated, two additional pre-commands in the VTS PGC command table are executed. The two additional pre-commands in the VTS PGC navigate away from the title to prevent playback and calls instead to the VMG domain. In the VMG domain, three additional commands navigate to an information page which displays an informational page to the user explaining why the selected title cannot be played back (e.g., because it is either encrypted or empty) and that a next title will be presented in a certain period of time or after a user interaction. If the title was encrypted on the disc, for example, the user may be shown a “VCPS title encryption warning”. The information page also includes either a regular button or an auto executed button that is executed after a predefined amount of time. The button contains a jump to the Next Title PGC which links to the next title in the VTS domain and the next title is played.

The foregoing features of the present invention will become more readily apparent and may be understood by referring to the following detailed description of an illustrative embodiment of the present invention, taken in conjunction with the accompanying drawings, where

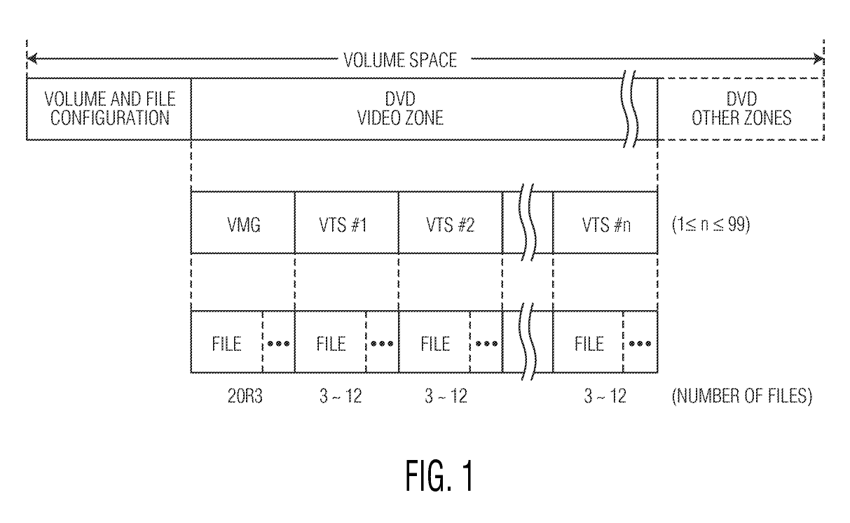

FIG. 1 shows volume space on a DVD-Video optical disk,

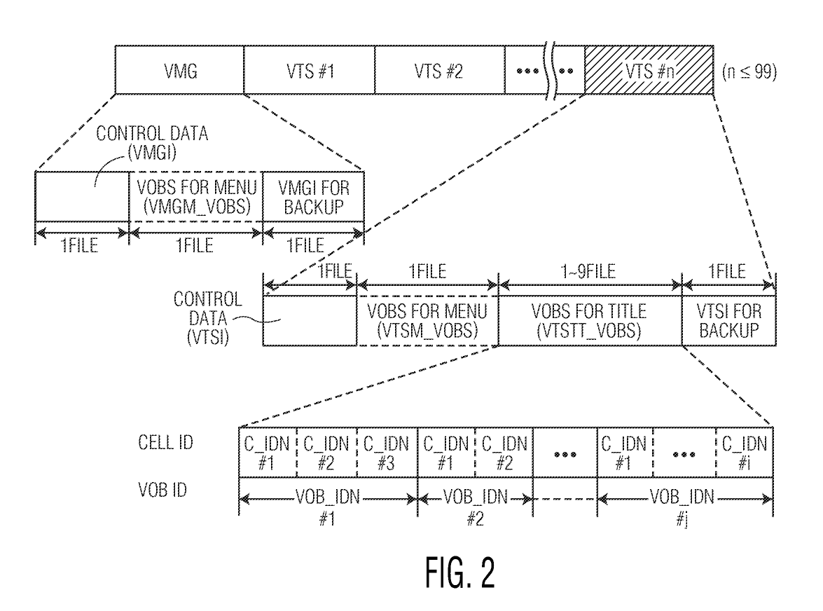

FIG. 2 shows the structures of the video manager (VMG) and the video title set (VTS) of the volume space of FIG. 1 in more detail,

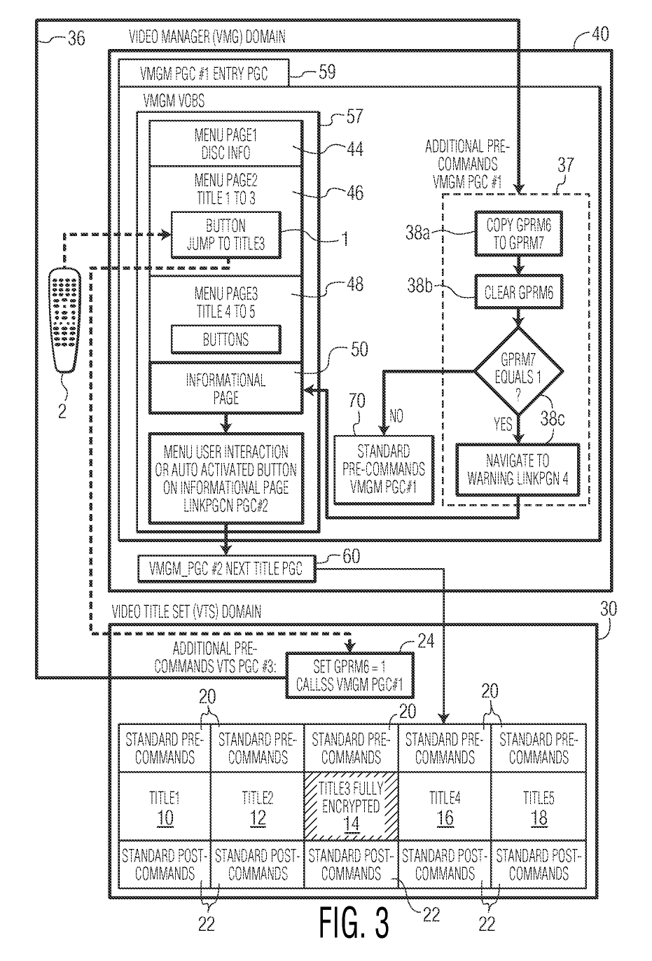

FIG. 3 is an exemplary block diagram of the DVD+RW video disc illustrating one embodiment of the invention,

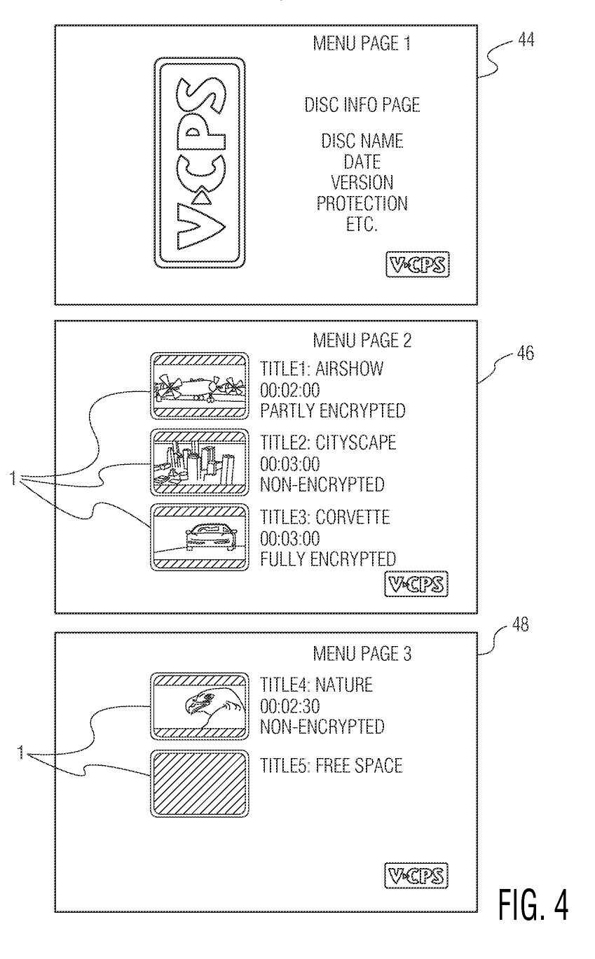

FIG. 4 is an exemplary illustration of a typical set of Menu Pages that are available to be shown to a user when interacting with a DVD+RW formatted disc, and

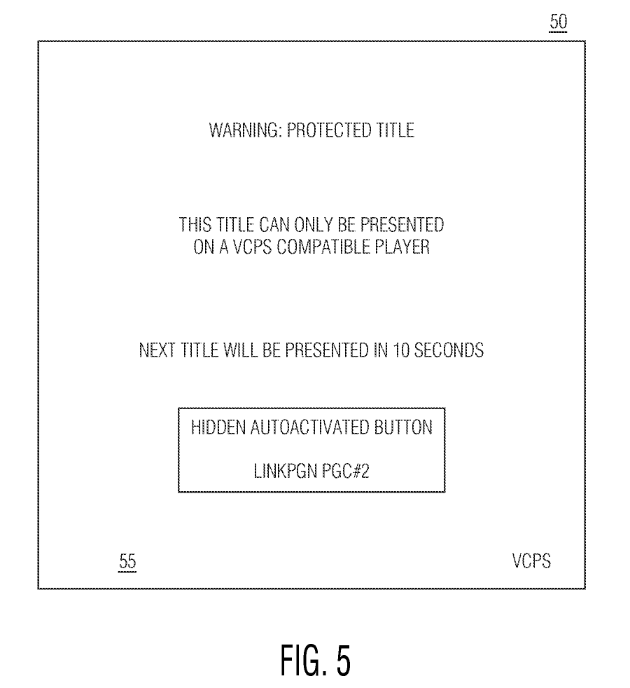

FIG. 5 is an exemplary illustration of informational page that resides in ‘Menu page’ of the Disc Menu.

A preferred embodiment of the invention will be described herein below with reference to the drawings. The following embodiment relates to a case where the invention is applied to a method for providing a user with additional information for better user-interaction and understanding of a DVD+RW (DVD-Rewritable) optical disc. The invention is applicable to any C.E. DVD+RW recorder, C.E. hard disk recorder and PC/MAC DVD+RW authoring application, whenever it is necessary to substitute a title with an informational page explaining why a selected title cannot be played back and that a next title will be presented in a certain period of time or after a user interaction.

FIG. 1 shows a volume space on a DVD-Video optical disk. As shown in FIG. 1, the volume space consists of a volume and file configuration zone, a DVD-video zone, and other zones. In the volume and file configuration zone control data is recorded according to a configuration format (e.g. UDF Universal Disk Format Specification Revision 1.02), the data of which can be read by any computer or C.E. device that meets a predetermined standard. The DVD-video zone has a video manager (VMG) and one or more video title sets (VTS). The video manager (VMG) and the video title set(s) (VTS) each consist of multiple files. The video manager (VMG) is information for controlling the video title set(s) (VTS). The video title set (VTS) is a unit describing a complete video content or ‘title’.

FIG. 2 shows the structures of the video manager (VMG) and the video title set (VTS) in more detail. The video manager (VMG) has video manager information (VMGI) as control data and a video object set (VMGM_VOBS) as data for menu display. A video object set (VOBS) is a collection of video objects (VOB). A VOB being an MPEG program stream made up of a group of elementary streams, such as video, audio, sub-picture, program control information (PCI) and data search information (DSI). Also included is a backup video manager information (VMGI_BUP) that is identical in content to the VMGI.

The video title set (VTS) contains video title set information (VTSI) as control data, optionally a video object set (VTSM_VOBS) as data for menu display, and a video object set (VTSTT_VOBS) for the title of a video title set that is a video object set for video display. Also, backup video title set information (VTSI_BUP) that is identical in content to the VTSI is included. The video object set (VTSTT_VOBS) for video display is made up by multiple cells. Each cell is assigned a cell identification number.

FIG. 3 is an exemplary block diagram of the DVD+RW video disc to illustrate a method, according to one embodiment, for providing a user with additional information for better user-interaction and understanding of a DVD+RW (DVD-Rewritable) optical disc.

Referring to FIG. 3, in the present example, the DVD+RW disc is assumed to store 5 titles, ‘Title 1’ 10, ‘Title 2’ 12, ‘Title 3’ 14, ‘Title 4’ 16 and ‘Title 5’ 18. The five titles 10-18 are located in the video title set (VTS) domain (30). The DVD+RW disc includes a Disc Menu comprised of multiple pages ‘Menu Page 1’ 44, ‘Menu Page 2’ 46, ‘Menu Page 3’ 48 and ‘Menu Page 4’ 50 where a first page, ‘Menu Page 1’ 42 contains disc information. ‘Menu page 2’ 46 and ‘Menu Page 3’ 48 each contain links for to up to three titles. That is, ‘Menu page 2’ 46 contains links for titles 1-3 and ‘Menu Page 3’ 48 contain links for titles 4-6. Note, in the present FIG. 4 is an illustrative example of a typical set of Menu Pages 1-4 44, 46, 48 and 50 that are available to be shown to a user when interacting with a DVD+RW formatted disc. As shown, Menu Page 1 44 is a disc information page including general disc illustrative example, the disc includes a total of 5 titles. The fourth menu page, ‘Menu Page 4’ 50 is an informational page (see FIG. 5), described further below, for visually and/or audibly instructing a user in response to the user selecting an empty or encrypted title from the menu system (e.g., Title 3 14).

FIG. 4 is an illustrative example of a typical set of Menu Pages 1-4 44, 46, 48 and 50 that are available to be shown to a user when interacting with a DVD+RW formatted disc. As shown, Menu Page 1 44 is a disc information page including general disc information including, for example, the disc name, the date, the disc version number, disc protection protocols in use and so on. Menu Page 2 46 contains links to titles 1-3 on the disc, i.e., ‘Airshow’, Cityscape’ and ‘Corvette’. Menu Page 3 48 contains links to titles 4-5 on the disc, i.e., ‘Nature’ and ‘Free Space’, and is capable of showing a third title if necessary. Menu page 4 50 is an informational page 50 to be displayed to the user to provide an informational page explaining why a selected title cannot be played back and that a next title on the disc will be displayed instead. The informational page 50 is described in detail further below.

By way of example, the third title on the disc, Title 3—‘Corvette’ 14, whose associated link is on Menu page 2 46 is arbitrarily selected to be an encrypted title. The other titles on the disc, namely, Titles {1, 2, 4 and 5} 10, 12, 16 and 18 are assumed not to be encrypted and therefore available to be played without difficulty when selected by a user.

Encrypted titles, such as Title 3—‘Corvette’ 14 in FIG. 3, present difficulties to the user, as discussed above, because an encrypted title is not playable on a DVD+RW formatted disc and cause the player to skip to the next title on the disc without providing any warning to the user as to what has occurred. This is confusing to the user in that a different ‘title’ is being played than the one selected. The invention overcomes this problem by providing the user with additional information (e.g., a visual and/or audible warning) explaining why a selected title cannot be played back and that a next title will be presented in a certain period of time or after a user interaction. A method and navigation structure, according to invention principles is described as follows.

Referring again to FIG. 3, in operation, the user has the option to select any of the five titles 10-18, which are collectively displayed on ‘Menu Page 2’ 46 and ‘Menu Page 3’ 48, either by activating a title button 1 from the Disc Menu 44-50 or by manually selecting a title via the remote control 2.

When the user selects a title 10-18, the corresponding standard pre-commands 20 and post-commands 22 inside the selected title's program chain (PGC) in the video title set (VTS) domain 30 are executed.

Whenever a user selects an encrypted (or empty) title (e.g., title 3 14), the title's corresponding VTS program chain (PGC) includes two additional pre-commands 24 which serve to navigate away 36 from the encrypted (or empty) title to prevent playback. The two additional pre-commands calls instead to the video manager (VMG) domain 40.

Navigating away from the VTS domain 30 to the VMG domain 40 in the case where an encrypted or empty title is selected by the user is necessary to overcome a limitation inherent in the DVD+RW video format. Specifically, the DVD+RW video format doesn't allow for the addition of titles to the VTS domain 30 which are not referenced on the DVD+RW video format. A referenced title is a title that has been recorded on the DVD+RW disc. The informational page 50 of the invention is not considered a referenced title because it was not recorded on the DVD+RW disc but only added as additional information (e.g., informational page 50) to a menu page, i.e., ‘Menu page 4’ 48 in the present example. In other words, the informational page 50 is considered to be non-recorded data, i.e., data added for informational purposes only. To overcome this limitation, the inventor has recognized that the informational page 50 can be displayed to the user in a manner that does not violate the DVD+RW format. Specifically, by placing the information page 50 in the VMG domain 40 and navigating towards it from the VTS domain 30 whenever the user selects an encrypted (or empty) title, the user may be shown the informational page 50 without violating the DVD+RW video format.

The limitation of the DVD+RW format, discussed above, is a consequence of there being no provision for a VTSM VOBS in the video title set (VTS) to display informational titles. It should be appreciated, however, that this limitation is unique to the DVD+RW video format. That is, there is no such limitation in the standard DVD-Video format which allows for the inclusion of VTSM VOBS as standard menu pages within a regular DVD's video title set (VTS). In the case of a regular DVD-Video disc, the informational title can be included in the VTSM VOBS which removes the need to navigate away to the VMG domain to display the informational title as taught in the present application.

As stated above, whenever a user selects an encrypted or empty title (e.g., title 3 14), the title's corresponding VTS program chain (PGC) includes two additional pre-commands 24 which serve to navigate away 36 from the encrypted (or empty) title to prevent playback and calls instead to the video manager (VMG) domain 40. It is noted that a title will only be substituted in the case where the additional pre-commands 24 are provided in the VTS program chain (PGC). Otherwise, processing of the title occurs in a normal manner, as is well known.

In one embodiment, the two additional pre-commands (24) used to navigate away from the VTS domain 30 and towards the VMG domain 40 are shown as:
1^{ST} Additional VTS PGC Pre-command—GPRM6=1
2^{nd} Additional VTS PGC Pre-command—CallSS VMGM PGC#1

The first additional VTS PGC pre-command, {PGPRM6=1} 24, sets a general parameter, which can be any parameter, to indicate to the pre-commands included in the VMG entry PGC, i.e., PGC#1 38 that a link is required to another part of the disc (i.e., the VMG domain 40).

The second additional VTS PGC pre-command, {CallSS VMGM PGC#1} 24, is an actual DVD Video command whose purpose is to jump to the entry program chain (entry PGC), PGC#1 38, of the VMG domain (40).

Upon executing the two additional VTS PGC pre-commands 24 in the VTS domain 30, control is then transferred to the VMG domain 40 where three additional pre-commands in the VMG domain entry PGC#1 37 navigate to an information page 50 to display a visual and/or audible instruction (warning) to a user explaining why the selected title, (e.g., title 3, the encrypted title) cannot be played back and provides a further indication to the user that a next title, e.g., ‘title 4’ 16, will be presented in a certain period of time or after a user interaction.

Processing of the three additional pre-commands 38 in the VMGM entry PGC, i.e., PGC#1 for navigating to an information page 50 to display a visual and/or audible instruction or warning is described now in more detail as follows.

The first additional VMG PGC pre-command 38a in PGC#1 37 is a copy command,

1^{ST} Additional VMG PGC Pre-command—Copy GPRM6 to GPRM7

This first additional VMG PGC pre-command 38a in PGC#1 37 copies the general parameter, GPRM6 to a temporary parameter, GPRM7. Copying the general parameter GPRM6 to the temporary parameter GPRM7 is necessary because if the general parameter GPRM6 were to remain set to 1 after an attempted access to an encrypted or empty page, thereafter, when the user makes a further selection, of any page, the warning page 50 will always be displayed, which is incorrect. Accordingly, copying the general parameter GPRM6 to the temporary parameter GPRM7 overcomes this undesirable result, whereby each access is independent of the previous access.

The second additional VMG PGC pre-command 38b in PGC#1 is a set command that clears general parameter GPRM6:
2^{nd} Additional VMG PGC Pre-command—Set GPRM6=0
   The third additional VMG PGC pre-command 38c is:

3rd Additional VMG PGC Pre-command—If GPRM7=GPRM6 then LinkPGN4

This third additional VMG PGC pre-command 38c directs the process towards displaying the informational page 50 in the event a user has selected an encrypted or empty page, (i.e., if GPRM7=1). Otherwise the process is directed towards processing the standard pre-commands 70 in PGC#1 37. Processing the standard pre-commands is well known and will therefore not be further discussed.

In the case where the user selects either an encrypted (or empty) file, the ‘YES’ branch (see navigation structure of FIG. 3) will be taken and the player links to the informational page 50 within the VMGM VOBS 57 of the VMG Domain 40. The informational page 50 contains the informational warning and in certain embodiments may also include DVD video/audio.

FIG. 5 is an illustration of informational page 50 that resides in ‘Menu page 4’ 48 of the Disc Menu 44-50. Note that any free menu page may be used to store the informational page 50. Note also that the warning displayed to the user can be different in different applications. For example, some typical warnings may recite, “This title is encrypted” for an encrypted title on the disc, “This title is deleted” for a deleted title on the disc, “This title doesn't contain any cells, please select the Full Title”. This warning message may be used in the case where a user has removed all cells from a playlist (PGC), or “This title is not copied to hard disk” for a title not copied to the hard disk. This warning message may be used in the case where a DVD+RW disc is copied to the hard-disk of a hard-disk recorder. It is possible that not all titles are copied to save additional space or because the content was not interesting in the user point of view.

In addition to the warning, the information page 50 preferably further includes either a regular menu button or an auto executed button 55, such as the one shown, that is executed after a predefined amount of time. The button 55 is configured to jump to the Next Title PGC 60 (see FIG. 3) which links to the next title in the VTS domain to be played. In the present example, the next title in the VTS domain to be played is title 4 16.

### CONCLUSION

In conclusion, it is shown that the invention provides a user with additional information for better user-interaction and understanding of a DVD+RW (DVD-Rewritable) optical disc. Specifically, a method and navigation structure is disclosed that provides a user with a visual and/or audible instruction or warning explaining why a title selected on a DVD+RW formatted disc cannot be played back and that a next title will be presented in a certain period of time or after a user interaction.

Although this invention has been described with reference to particular embodiments, it will be appreciated that many variations will be resorted to without departing from the spirit and scope of this invention as set forth in the appended claims. The scope of the invention is indicated in the appended claims, and all changes that come within the meaning and range of equivalents are intended to be embraced therein. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts is intended to be required unless specifically indicated.

1. A method for providing a user with additional information for better user-interaction and understanding of a DVD+RW (DVD-Rewritable) optical disc, the method comprising the acts of:
(a) selecting a title (10-18) via a disc menu (44-50) of the DVD+RW optical disc,
(b) preventing playback of a non-playable selected title (14),
(c) providing the user with a visual and/or audible instruction or warning explaining why the non-playable selected title (14) cannot be played back from the DVD+RW optical disc, and
(d) presenting a next title (16) to the user within a certain period of time or after a user interaction.

2. The method of claim 1, further comprising the acts of, performed prior to said act (a):
including additional pre-commands (24) to the pre-existing pre-commands (20) and post commands (22) inside each non-playable title's (14) program chain (PGC) in the video title set (VTS) domain (30), and
including additional pre-commands (38) inside the entry program chain (PGC) (59) in the video manager (VMG) domain (40).

3. The method of claim 2, wherein the act of preventing playback of the selected title (14) further comprises navigating away from the video title set (VTS) domain (30) of the disc towards an information page (50) of the video manager (VMG) domain (40) of the disc.

4. The method of claim 3, wherein the act of navigating away from the VTS domain (30) of the disc towards the information page (50) of the VMG domain (40) of the disc further comprises the acts of:
executing the additional pre-commands (24) in the VTS domain (30) to navigate to the VMG domain (40), and
executing the additional pre-commands (38) in the VMG domain (40) to navigate to the information page (50).

5. The method of claim 1, wherein the information page (50) of the VMG domain (40) provides the visual and/or audible instruction or warning provided to the user and informs the user that the title being played is a next title on the disc different from the selected title.

6. The method of claim 6, wherein the information page (50) is a non-referenced title recorded on the DVD+RW disc.

7. The method of claim 5, wherein the information page (50) is stored as a menu page in the VMGM VOBS (57) in the VMG domain (40).

8. An optical disc including a navigation structure for navigating a title away from a video title set VTS domain (30) on the optical disc to an information page (50) in the video management VMG domain (40) of the optical disc, without disrupting the DVD+RW video structures, the navigation structure comprising:
additional pre-commands (24) added to the pre-existing pre-commands (20) and post commands (22) inside each non-playable title's (14) program chain (PGC) in the video title set (VTS) domain (30) for navigating away from the (VTS) domain (30) and towards the (VMG) domain (40), and
additional pre-commands (38) added to the entry program chain (PGC) (59) in the video manager (VMG) domain (40) for navigating towards an information page (5) in the VMGM VOBS of the (VMG) domain (40).

9. The optical disc of claim 8, wherein the information page (50) includes a button (55) configured to jump to a Next Title PGC (60) in the VTS domain (30) which links to the next title in the VTS domain (30) to be played.

10. The optical disc of claim 9, wherein the button (55) is a regular menu button or (b) an auto executed button (55) that is executed after a predefined amount of time.

11. The optical disc of claim 8 for use in any one of a C.E. DVD+RW recorder, C.E. hard disk recorder and PC/MAC DVD+RW authoring application.
